(19) United States
(12) Patent Application Publication
(10) Pub. No.: US 2009/0277822 A1
(43) Pub. Date: Nov. 12, 2009

(54) CHANGEABLE CONTINUOUS FLOW MODULAR SYSTEM FOR THE TREATMENT OF WATER STREAMS

(76) Inventors: Joao Carlos GOMES DE OLIVEIRA, Sao Paulo (BR); Procopio GOMES DE OLIVEIRA NETTO, Sao Paulo (BR); Felipe GOMES DE OLIVEIRA, Sao Paulo (BR)

Correspondence Address: TUROCY & WATSON, LLP, 127 Public Square, 57th Floor, Key Tower, CLEVELAND, OH, 44114, US

(21) Appl. No.: 12/332,115

(22) Filed: Dec. 10, 2008

(30) Foreign Application Priority Data
May 9, 2008 (BR) PI 0802065-5

(51) Int. Cl. C02F 9/00

(52) U.S. Cl. 210/202; 210/259

(57) ABSTRACT

A changeable continuous flow modular system for the treatment of water streams that makes it possible to treat any polluted water stream (CA) being submitted to an anaerobic process or not (0), through the implementation of an aerobic biological process (1) with aeration and oxidation of the water stream (CA) followed of a physical-chemical process (2), according to patent PI9702430-9, followed by an aerobic biological process with aeration and oxidation of the water stream (3) and once again by a physical-chemical process (4).

### DISCLOSURE OF THE INVENTION

The present invention is directed to a changeable continuous flow modular system for the treatment of water streams, and more specifically to a process for removing suspended and dissolved organic and inorganic matter present in polluted water streams, by using a combination of biological and physical-chemical processes.

As is known, the pollution of waters has been a problem for the whole society, the main areas of concern being the ones located near human agglomerations.

The pollution of water indicates that it may be damaged by one or more uses thereof and may strike the population directly, since it is used for drinking, bathing, washing clothes and utensils and, mainly, for feeding humans and domestic animals. Further, it supplies our cities and is also used in industries and for irrigating plantations. Therefore, the water must have a clean aspect, pureness of taste and be free of pathogenic microorganisms, what it is attained through its treatment, from the moment it is collected in rivers and dams to the time it gets to urban residences or rural areas.

The water of a river is considered as being of good quality when it contains less than a thousand fecal coliforms and less than ten pathogenic microorganisms per liter (such as those that cause verminosis, cholera, schistosomiasis, typhoid fever, hepatitis, leptospirousis, polio, etc.). Therefore, in order that the water may remain under such conditions, its contamination by agricultural waste (either chemical or organic), sewers, industrial waste, garbage or erosion sediments must be prevented.

Among other factors, the causes of water pollution include domestic sewers, industrial wastes, rain-water draining in urban areas as well as irrigation waste waters. In other words, the main causes of water pollution are the collection of non-treated sewer, regions where the sewer is not collected, the large amount of domestic and industrial garbage, clandestine dump areas, rain-water draining in impervious surfaces such as streets, buildings and other paved areas that carry the surface pollution, added to the excessive amount of fertilizers that get into the ground and pollute underground water.

The presence of a high content of organic matter may bring about the complete depletion of oxygen in the water, ending up in the disappearance of fish and other forms of aquatic life. A high BOD value may indicate an increment of the micro-flora present in the water and intervene with the balance of aquatic life, besides producing unpleasant flavors and odors.

In order to prevent water deterioration, the government and the industries must invest in efficient sewer systems that may allow a fast and safe removal of waste water, dejects and liquid wastes derived from human activities, as well as systems that convey and treat the removed material. Moreover, the population must be aware of the pollution and environment issues, since the more efforts made in order to preserve the water the better and cheaper the treatment thereof, and therefore the population will be rewarded.

However, nowadays only a few countries have a preventive planning for the construction of sewer collecting networks and an efficient sanitation system.

Thus, there are several types of water treatment in the market today whose aim is to improve the sanitary, economic and social conditions of the populations affected by such problems.

It occurs that the most of the water treatments involve highly expensive systems, since they require the accomplishment of large civil works that comprise the construction of sewer elevating plants, outflow reduction tanks, anaerobic and/or aerobic reactors, tanks for coagulation basins, flocculation, sedimentation or flotation, filtration, among others. Besides increasing the costs of the systems, such works slow the implementation thereof and prevent same from being suited to all types of water streams.

Aiming at overcoming the usual problems, the inventors have developed a changeable continuous flow modular system for the treatment of water streams, through which suspended and dissolved organic and inorganic matter present in the water stream itself is removed, making it possible to exploit the water resources for future reutilization; the implementation and development of industries; the use of urban water streams as elements for recreation purposes and sports; and the conservation of natural water resources against excessive pollution and its maintenance under conditions of thorough use.

Another object of the present invention is to provide a modular system with changeable continuous flow for the treatment of water streams with a low implementation cost that may be adapted to any type of water stream (CA).

Another object of the present invention is to provide a modular system with changeable continuous flow for the treatment of water streams that is easy and fast to implement when compared to known methods, requiring small adaptations in the spot where it is installed along the water stream (CA).

Another object of the present invention is to provide a modular system with changeable continuous flow for the treatment of water streams that may fulfill the previously established quality standard requirements for treated waters in spite of receiving polluted loads in some intermediate module of the system.

Another object of the present invention is to provide a modular system with changeable continuous flow for the treatment of water streams that is easy to construct, operate and maintain at reduced costs, besides being satisfactorily efficient even with changing polluting load, outflow and water stream level changes.

Another object of the present invention is to provide a modular system with changeable continuous flow for the treatment of water streams that makes use of combinations of biological and physical-chemical processes and, aiming at to the anticipation of the results in cleaning the water body, improves the quality of the water in a much shorter time and requires less resources to be available.

These and other objects and advantages of the present invention are attained through a changeable continuous flow modular system for the treatment of water streams that makes it possible to treat any polluted water stream, being submitted to an anaerobic process or not (0), through the implementation of an aerobic biological process (1) with aeration and oxidation of the water stream (CA) followed of a physical-chemical process (2), according to patent PI9702430-9, followed by an aerobic biological process with aeration and oxidation of the water stream (3) and once again by a physical-chemical process (4). It should be stressed out that the number and the way to associate the treatments may vary in accordance with the dimensions and characteristics of the water stream and its surroundings. A certain water stream of extensive length can be submitted to a number “n” of physical-chemical treatments followed or preceded by aerobic biological processes with aeration and oxidation of the water stream, that can also receive contributions from polluting loads along the treatments and continue assuring the previously established standards of quality.

The aerobic biological process (1) with aeration and oxidation of the water stream (CA) may comprise one or more aeration stations for recovering the levels of oxygen dissolved in the water, thus allowing the aerobic biological process that uses bacteria and the oxidant power of the aeration to consume organic matter and particular water-soluble substances without the need to add and mixture chemicals to the water stream (CA) to take place all over the first treatment, generating the effluent (E1) to be treated by the physical-chemical process (2).

The physical-chemical process (2), according to patent PI 9702430-9 of the same inventor comprises the stages of adding a flocculating or coagulating material to a spot of the water stream to be treated, adding particles in suspension, forming flakes of higher size and density that define a flocculation basin (F1) downstream the water stream (CA), submitting aggregate particles of higher size and density to at least a micro-aeration stage (M1) with micro-bubbles, that define a flotation basin (Fo1) along the water stream (CA), so that the agglomeration, concentration and thickening of the floated material take place; and promoting the removal (R) of the concentrated floated material. It should be stressed out that said micro-aeration stage may be replaced or complemented with a nanoaeration stage with the injection of nano-bubbles. The effluent (E2) treated by the physical-chemical process (2) proceeds to a third treatment comprising the aerobic biological process (3) with aeration and oxidation of the water stream (CA), since the physical-chemical treatment (2) saturates the water with oxygen. However, since the aerobic treatment consumes the oxygen dissolved in the water, one or more intermediate aeration stations may be used in this treatment for recovering the levels of oxygen dissolved in the water, thus allowing the aerobic biological process to take place all over the third treatment; after this module, the treated effluent (E3) may flow to a fourth treatment comprising the physical-chemical process (4), that will remove an important residual portion of the physical-chemical treatment (2) and the particulates generated in the treatment comprising the aerobic biological process (3) with aeration and oxidation of the water stream (CA).

According to patent PI9702430-9 of the same inventor, the physical-chemical process takes place along the water stream.

It is important to stress out that the above mentioned physical-chemical treatment processes are much more expensive than conventional treatment stations that comprise several treatment stages using steel or concrete tanks and elevating stations for pumping the water stream deviated. Also, the aerobic biological treatment with aeration and oxidation of the water stream is much cheaper, when compared to the physical-chemical treatment, since it uses bacteria and the oxidant power of the aeration to consume organic matter and particular soluble substances in the water without the need to add and mixture chemicals to the water stream. Said aeration can be carried out by macro-bubbles, micro-bubbles, nano-bubbles with the surrounding air, oxygen-rich air or even pure oxygen, in such a way that the transfer of oxygen to the water can take place in several ways.

The present changeable continuous flow modular system for the treatment of water streams will be described below with reference to the attached drawings, given as an example without limiting same, wherein:

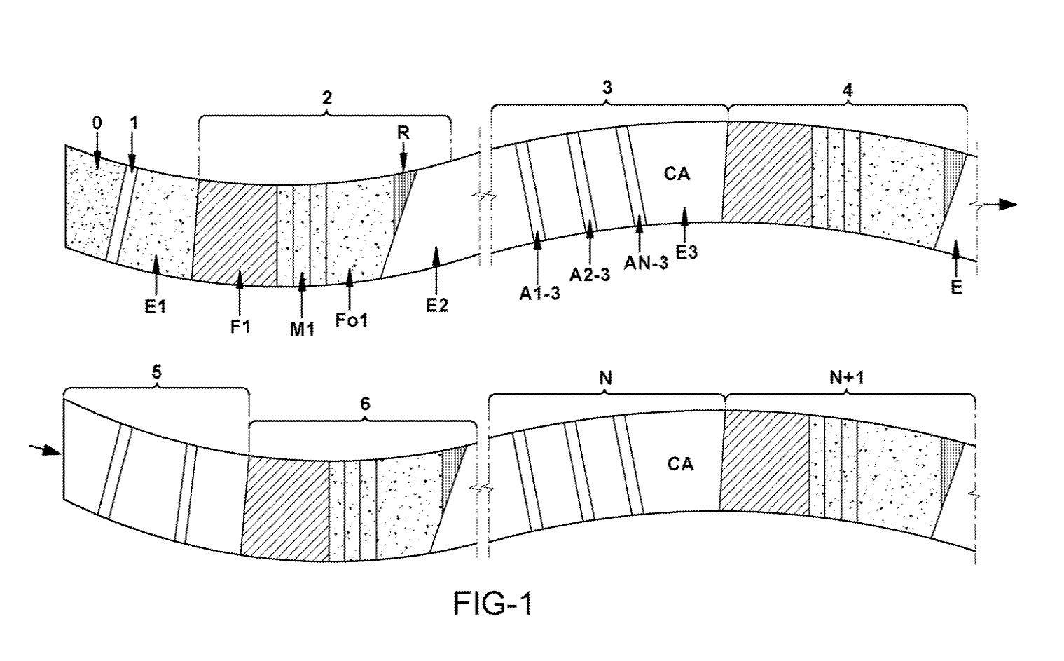

FIG. 1 represents schematically a spot of water stream (CA) being submitted to an anaerobic process or not (0), that is submitted to the changeable continuous flow modular system for the treatment of water streams in question, in the case of a first aerobic biological treatment (1) with aeration and oxidation of the water stream (CA), a second treatment comprising a physical-chemical process (2), a third aerobic biological treatment (3) with oxidation of the effluent and a fourth physical-chemical treatment (4); and

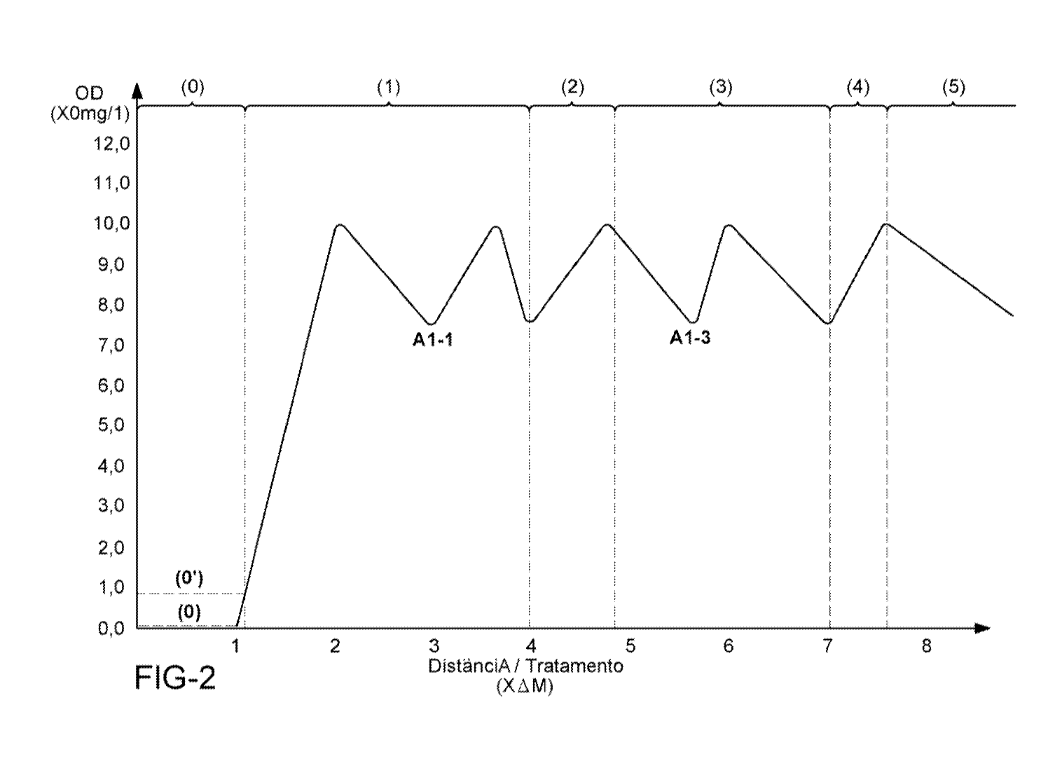

FIG. 2 is a graphical representation of the determination of the positioning of the aeration stations in aerobic biological treatments with aeration and oxidation of the water stream.

In accordance with FIG. 1, the changeable continuous flow modular system for the treatment of water streams is installed in a polluted spot of water stream (CA) being submitted to an anaerobic process or not (0), that starts receiving a first aerobic biological treatment (1) with aeration and oxidation of the water stream (CA). The treatment (2) refers to the physical-chemical process.

Still in accordance with FIG. 1, the treatment comprising the aerobic biological process (3) with aeration and oxidation of the water stream (CA) may comprise one or more intermediate aeration stations (A1-3), (A2-3), (An-3), used in this treatment for recovering the levels of oxygen dissolved in the water.

In FIG. 1, the treatment (4, 6) again refers to a physical-chemical process.

Thus, there can be a number (n) of physical-chemical processes followed or preceded by aerobic biological processes with aeration and oxidation of the water stream (CA) that are quantified, distributed and dimensioned in accordance with the hydraulic characteristics of polluting physical loads among others of the water stream and its polluted minor streams.

Although the process has been described and illustrated, it should be stressed out that constructive changes and applicability are possible and attainable without departing from the scope of the present invention.

1. A changeable continuous flow modular system for the treatment of water streams (CA), characterized in that it is possible to treat a polluted water stream (CA) being submitted to an anaerobic process or not (0), through the implementation of an aerobic biological process (1) with aeration and oxidation of the water stream (CA) followed by a physical-chemical process (2) carried out through the process of removing polluting materials and/or substances contained in the water stream, followed by an aerobic biological process (3) with aeration and oxidation of the water stream (CA) and once more by a physical-chemical process (4).

2. The changeable continuous flow modular system for the treatment of water streams according to claim 1, characterized in that the biological aerobic process (1) with aeration and oxidation of water stream (CA) is provided with one or more aeration stations for recovering levels of oxygen dissolved in the water, allowing the aerobic biological process that uses bacteria and the oxidant power of the aeration to consume organic matter and particular water-soluble substances without the need to add and mixture chemicals to the water stream (CA) to take place all over the first treatment, generating the effluent (E1) to be treated by the physical-chemical process (2).

3. A changeable continuous flow modular system for the treatment of water streams, wherein the physical-chemical process (2), comprises the stages of adding a flocculating or coagulating material to a spot of the water stream to be treated, adding particles in suspension, forming flakes of higher size and density, that define a flocculation basin (F1) downstream the water stream (CA), submitting aggregate particles of higher size and density to at least a micro-aeration stage (M1) with micro-bubbles, that define a flotation basin (Fo1) along the water stream (CA), so that the agglomeration, concentration and thickening of the floated material take place; and promoting the removal (R) of the concentrated floated material, said physical-chemical process (2) taking place along the water stream and according to claim 1, characterized in that the micro-aeration stage may be replaced or complemented with a nanoaeration stage with the injection of nano-bubbles.

4. The changeable continuous flow modular system for the treatment of water streams according to claim 1 or 3, characterized in that the effluent (E2) is transferred to a third treatment comprising an aerobic biological process (3) with aeration and oxidation of the water stream (CA) after being treated by the physical-chemical process, so that one or more intermediate aeration stations (A1-3), (A2-3), (An-3) may be installed along the treatment comprising the aerobic biological process (3).

5. The changeable continuous flow modular system for the treatment of water streams according to claim 1 or 4, characterized in that the treated effluent (E3) proceeds to a physical-chemical treatment (4) that will remove the residual portion of the physical-chemical treatment (2) and the particulates generated in the treatment comprising the aerobic biological process (3) with aeration and oxidation of the water stream (CA).

6. The changeable continuous flow modular system for the treatment of water streams according to claim 1 or 2 or 3 or 4 or 5, characterized in that the number (n) and the association of physical-chemical processes may be followed or preceded by aerobic biological processes with aeration and oxidation of the water stream (CA), quantified, distributed and dimensioned in accordance with the water characteristics, polluting physical loads among others of the water stream and its polluted minor streams.
